(19) United States
(12) Patent Application Publication
(10) Pub. No.: US 2006/0245456 A1
(43) Pub. Date: Nov. 2, 2006

(54) Systems and methods for generating high repetition rate ultra-short optical pulses

(75) Inventors: Jacob Lasri, Boulder, CO (US); Kurt R. Vogel, Boulder, CO (US); Neil Claussen, Longmont, CO (US); Christopher J. Myatt, Boulder, CO (US)

Correspondence Address: FAEGRE & BENSON LLP;PATENT DOCKETING, 2200 WELLS FARGO CENTER, 90 SOUTH 7TH STREET, MINNEAPOLIS, MN, 55402-3901, US

(73) Assignee: Precision Photonics Corporation, Boulder, CO (US)

(21) Appl. No.: 11/243,798

(22) Filed: Oct. 4, 2005

Related U.S. Application Data
(60) Provisional application No. 60/675,490, filed on Apr. 28, 2005.

(51) Int. Cl. H01S 3/30; H01S 3/113; H01S 3/098; H01S 3/10

(52) U.S. Cl. 372/18; 372/11; 372/20; 372/25; 372/6

(57) ABSTRACT

Systems, methods, circuits and/or devices for generating high repetition rate ultra-short pulses are described. As one of many examples, an optical pulse generating laser system is described that produces mode-locked optical pulses. The laser system incorporates an optical pulse generation device that includes two optical loops coupled via a beam splitter. In addition, the optical pulse generation device includes an optical gain medium that is associated with the first optical loop, and a saturable element that is disposed in either the first optical loop or the second optical loop. The saturable element is operable to modulate a group of optical pulses propagating in at least one of the first optical loop and the second optical loop to create a group of substantially regular modulated pulses.

### CROSS REFERENCE TO RELATED APPLICATIONS

The present application claims priority to U.S. Provisional Patent Application No. 60/675,490 filed on Apr. 21, 2005. The aforementioned provisional patent application is owned by an entity common hereto, and is included herein by reference for all purposes.

### BACKGROUND OF THE INVENTION

The present invention relates generally to optical pulse generators, and more particularly, to mode-locked fiber laser generators of short optical pulses with high repetition rates.

Various applications require ultra-short optical pulses with megahertz or higher repetition rates. Some examples of the applications include high-speed time-domain-multiplexed optical communication links, signal processing systems employing optical sampling, material processing, and biological imaging. Mode-locked semiconductor lasers have been considered as a vehicle for providing high frequency, ultra-short optical pulses. However, such lasers generally have relatively complex assembly requirements involving precise mechanical alignment of bulk-optic components. Other approaches that have less complex assembly requirements have also been considered. For example, a fiber laser provides ease of assembly and flexibility with regard to insertion of optical components within the cavity. However, while existing fiber lasers may be able to generate relatively short optical pulses, they typically cannot support a high repetition rate due to the cavity's low fundamental mode frequency (e.g., less than one hundred megahertz), and the relatively poor synchronization property of the mode-locked pulses due to the self-initiation of the lasing conditions caused by noise fluctuations. Various approaches may be used to improve repetition rate and pulse synchronization in such lasers, however, these approaches typically result in relatively long pulses (e.g., greater than one picosecond).

Hence, for at least the aforementioned reasons, there exists a need in the art for advanced systems and methods for producing short optical pulses with high repetition rates.

### BRIEF SUMMARY OF THE INVENTION

The present invention relates generally to optical pulse generators, and more particularly, to mode-locked fiber laser generators of short optical pulses with high repetition rates.

Various embodiments of the invention including systems, methods, circuits and/or devices for generating high repetition rate ultra-short pulses are disclosed. Some embodiments of the present invention provide optical pulse generating laser systems that produces mode-locked optical pulses. Laser systems in accordance with the embodiments incorporate an optical pulse generation device that includes two optical loops coupled via a beam splitter. In addition, the optical pulse generation device includes an optical gain medium that is associated with the first optical loop, and a saturable element that is disposed in either the first optical loop or the second optical loop. The saturable element is operable to modulate a group of optical pulses propagating in at least one of the first optical loop and the second optical loop to create a group of substantially regular modulated pulses. In some instances of the embodiments, the optical pulse generation device includes an optical gain element and a saturable element that are implemented as a semiconductor optical amplifier. In one particular case, the optical gain medium is a semiconductor optical amplifier. Based on the disclosure provided herein, one of ordinary skill in the art will recognize other optical gain media that may be used in accordance with one or more embodiments of the present invention.

Other embodiments of the present invention include systems for providing high repetition rate, ultra-short optical pulses. Such systems include an optical pulse generation device with a figure-eight optical path and a saturable element. The optical pulse generation device further includes a cavity that can support multiple pulses. In some instances of the embodiments, the figure-eight optical path includes two optical loops optically coupled via a beam splitter. In such a configuration, one of the optical loops may include an optical gain medium, and a saturable element is disposed in at least one of the optical loops. Thus, in one particular case, the saturable element may be disposed in the optical loop that includes the optical gain element, while in another case the saturable element may be disposed in the other optical loop. The aforementioned cavity may include, but is not limited to, one optical loop of figure-eight or both loops of the figure-eight. Further, based on the disclosure provided herein, one of ordinary skill in the art will recognize a variety of other cavities that may be utilized in relation to one or more embodiments of the present invention.

Various different saturable elements may be used in accordance with different embodiments of the present invention. As just some examples, the saturable element may be a saturable gain medium or a saturable loss medium. A saturable gain medium may be, but is not necessarily limited to, an optical element with a gain that is saturated as a function of the intensity of an input optical signal. In contrast, a saturable loss medium may be, but is not necessarily limited to, an optical element that does not provide a gain, and is saturated as a function of the intensity of an input optical signal. In particular instances, the saturable element may be formed of a material that exhibits an intensity-dependent transmission to enable propagation of multiple pulses within the cavity.

Various different semiconductor optical amplifiers may also be used in accordance with embodiments of the present invention. For example, the semiconductor optical amplifier that is utilized may be a quantum well semiconductor element, a quantum dash semiconductor element, or a quantum dot semiconductor element. The semiconductor optical amplifier modulates a group of pulses propagated by the optical pulse generation device to create a group of modulated output pulses. In some cases, the length of the pulses in the group of modulated output pulses is less than one picosecond. In particular cases, the length of the pulses in the group of modulated output pulses is less than two hundred femtoseconds.

In some instances of the embodiments, the systems further include a dispersion control section using, for example, an optical fiber with appropriate dispersion and length operable to minimize the total dispersion in the laser cavity. In addition, the systems include a wavelength tuning element that is operable to change the wavelength of light propagated by the optical pulse generation device within a spectral gain profile of the semiconductor optical amplifier. In some embodiments, the pulse generation device may also include a supermode selector using, for example, a Fabry-Perot etalon, operable to select one set of cavity supermodes in order to reduce the noise of the mode-locked pulses and to maintain a fixed pulse-to-pulse phase relationship. In various instances of the embodiments, the optical pulse generation device utilizes at least some polarization maintaining fiber and/or a polarization controller.

Various instances of the systems in accordance with the embodiments include an optoelectronic feedback loop to control the repetition rate. In such instances, the optoelectronic feedback loop may include an optical coupler that is optically coupled to the optical pulse generation device. A photodetector, which is optically coupled to the optical coupler, converts the group of substantially regular modulated pulses received from the optical pulse generation device to a group of electrical pulses. An electrical amplifier is electrically coupled to the optical coupler, and amplifies the group of electrical signals to form a corresponding group of amplified electrical signals. In addition, an electrical filter is included that is operable to select a single frequency electrical signal from the group of amplified electrical signals and therefore to set a repetition rate based at least in part by providing an electrical signal for driving the saturable element. In some cases, the repetition rate is adjustable. In some cases, the saturable element includes a bias input for receiving a DC bias for passive mode locking and an electrical AC input for active mode locking. In particular cases, the saturable element is a fast saturable element that is operable to modulate a group of pulses propagated by the optical pulse generation device with a repetition rate greater than ten MHz. In yet more particular cases, the repetition rate is greater than one GHz, and in others the repetition rate is greater than ten GHz. In one or more instances, the optoelectronic feedback loop further includes a high-Q photonic-based delay line. Such a resonator may be, for example, an optical delay line, a whispering gallery mode resonator, or an optical resonator.

In other cases, an optoelectronic feedback loop is incorporated in the systems and includes a voltage controlled oscillator (hereinafter “VCO”) that provides a radio frequency (hereinafter “RF”) output that is used to modulate the saturable element and control the repetition rate. The optoelectronic loop further includes an optical coupler that is optically coupled to the optical pulse generation device. A photodetector, which is optically coupled to the optical coupler, converts the group of substantially regular modulated pulses received from the optical pulse generation device to a group of electrical pulses. An electrical amplifier is include that is electrically coupled to the optical coupler, and amplifies the group of electrical signals to form a corresponding group of amplified electrical signals. In addition, an electrical mixer is included that compares the phase of the amplified electrical signal to that of the VCO and generates an error signal. A transducer is also included that controls the repetition rate. In one particular case, the transducer is a piezo electric transducer that physically stretches the optical fiber.

This summary provides only a general outline of some embodiments of the present invention. Many other objects, features, advantages and other embodiments of the present invention will become more fully apparent from the following detailed description, the appended claims and the accompanying drawings.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 depicts an existing passively mode-locked fiber laser in a figure-eight laser shaped configuration;

FIG. 2 depicts a passive harmonic mode-locking fiber laser using a fast saturable element-based figure-eight laser in accordance with various embodiments of the present invention;

FIG. 3 illustrates a passive harmonic mode-locking fiber laser with SOA-based figure-eight laser in accordance with other embodiments of the present invention;

FIG. 4a shows a hybrid harmonic mode-locking fiber laser using a fast saturable element-based figure-eight laser with an optoelectronic feedback loop in accordance with yet other embodiments of the present invention;

FIG. 4b depicts another hybrid harmonic mode-locking using a fast saturable element-based figure-eight laser with a PLL feedback control in accordance with various embodiments of the present invention; and

FIG. 5 depicts an exemplary series of pulses that may be generated using one or more embodiments of the present invention.

### DETAILED DESCRIPTION OF THE INVENTION

The present invention relates generally to optical pulse generators, and more particularly, to mode-locked fiber laser generators of short optical pulses with high repetition rates.

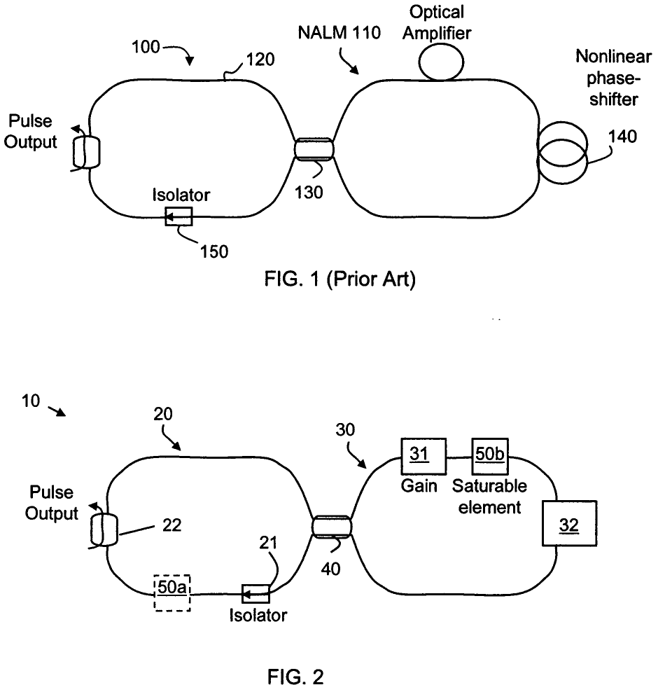

FIG. 1 illustrates a conventional pulse generating laser 100 based on a ring cavity 120 and a NALM 110 that are connected together by an optical coupler 130 to form a figure-eight laser (hereinafter “F8L”) configuration. In this case, light entering NALM 110 is split into clockwise (hereinafter “CW”) and counterclockwise (hereinafter “CCW”) propagating beams. The CW beam is amplified, using, for example, an erbium-doped fiber amplifier (hereinafter “EDFA”), prior to propagating through an intensity-dependent phase shifter 140. The CCW beam is amplified after propagating through phase shifter 140. The amplified CW and CCW beams return to optical coupler 130 at the same amplitude, but one beam has acquired a nonlinear phase shift relative to the other. This phase shift causes the high intensity portions of the beam to be transmitted through NALM 110, while the low intensity portions are reflected back in the direction that the beams entered in CCW direction. An optical isolator 150 in ring cavity 120 favors the transmission and amplification of the CW-directed high intensity portions of the light, resulting in mode-locking due to shortening and amplification of the pulses each time they pass through the nonlinear loop portion of the F8L. In such a configuration, if the overall dispersion within the F8L for one round trip is such that the pulse broadening due to linear dispersion is compensated by that of nonlinear dispersion, mode-locked optical solitons are generated.

A laser such as that shown in FIG. 1 can generate short (e.g., less than one hundred femptoseconds) optical pulses. However, the repetition rate of such lasers is typically limited by the relatively long cavity length to, for example, less than 100 MHz. To increase the repetition rate in soliton lasers, one can change the pump power in order to increase the number of propagating pulses per round trip since the cavity energy is quantized by the fundamental soliton energy. The multiple pulses in the cavity, however, typically form with arbitrary spacing and, in principle, any sufficiently large spike may evolve into a pulse. The timing of such noise spikes is inherently random. Therefore one cannot get stable mode locking at high repetition rates by just increasing the pump power alone.

Various embodiments of the invention including systems, methods, circuits and/or devices for generating high repetition rate ultra-short pulses are disclosed. Some embodiments of the present invention provide optical pulse generating laser systems that produces mode-locked optical pulses. Laser systems in accordance with the embodiments incorporate an optical pulse generation device that includes two optical loops coupled via a beam splitter. In addition, the optical pulse generation device includes an electrically pumped optical gain medium that is associated with the first optical loop, and a saturable element that is disposed in either the first optical loop or the second optical loop. The saturable element is operable to modulate a group of optical pulses propagating in at least one of the first optical loop and the second optical loop to create a group of substantially regular modulated pulses.

In some cases, approaches relying on passive harmonic mode-locking may be used to achieve short pulses with high repetition rates. In particular, lasers may be mode-locked in the anomalous (soliton) dispersion regime such that they produce multiple pulses per round trip since the cavity energy is quantized by the fundamental soliton energy. In other words, the gain may support many pulses per round trip. These pulses typically form with arbitrary spacing and interact strongly leading to erratic timing of the pulse train. Extracavity feedback and/or saturable absorbers may be added in an effort to control the pulse interactions and to provide timing of multiple pulses in the cavity through passive harmonic mode-locking. Further consideration may also be provided to suppress the cavity's fundamental (non-oscillating) modes, provide improved timing jitter of the pulses, and increase control of the repetition rate. Based on the disclosure provided herein, one possessing ordinary skill in the art will recognize a variety of approaches for achieving the aforementioned results.

Turning to FIG. 2, a passive mode-locking fiber laser in accordance with one or more embodiments of the present invention is illustrated, and referred to herein as optical pulse generating laser 10. As shown, optical pulse generating laser 10 includes an optical loop 20 and an optical loop 30 that are optically coupled by a beam splitter 40. As used herein, the term “beam splitter” is used in its broadest sense to mean any device capable of dividing an optical beam into two or more separate beams. The two coupled optical loops 20, 30 define a figure eight optical path in which a light beam propagating toward beam splitter 40 in one of the loops 20, 30 is divided by beam splitter 40 into two light beams propagating in opposite directions. In addition, optical pulse generating laser 10 includes a saturable element 50. Saturable element 50 may be included in either loop 30 or loop 20 as indicated by the dashed outline of saturable element 50a. By including saturable element 50, optical pulse generating laser 10 can utilize the nonlinear transmission characteristics of saturable element 50 to synchronize multiple pulses in the cavity and therefore increase the repetition rate beyond the limit imposed by the laser cavity's length. Further, this synchronization may be achieved while maintaining short pulse widths.

Optical loop 30 is configured as a NALM consisting of an optical gain medium 31 and a nonlinear element 32 that acts as an intensity dependent phase shifter. Optical loop 20 includes an isolator 21 that has a direction dependent loss, and an optical coupler 22 to extract at least a portion of the circulating pulses. Optical gain medium 31 can be any gain medium. As some of many examples, optical gain medium 31 may be an electrically pumped semiconductor optical amplifier (hereinafter “SOA”) or a length of rare earth doped optically pumped single-mode optical fiber. The peak gain wavelength of gain medium 31 may be in any wavelength band. Thus, for example, peak gain wavelength may be, but is not limited to, approximately 1550 nanometers, 1300 nanometers, or 1060 nanometers.

Saturable element 50 may be any optical component with a certain optical loss or gain, that is reduced for high optical intensities. Using such an element, intensity-dependent transmission can occur in a medium with absorbing dopant ions when a strong optical intensity leads to depletion of the ground state of these ions. Similar effects can occur in semiconductors materials having a band-gap equal to or less than a photon energy corresponding to said laser wavelength.

In operation, a pulse is generated in optical pulse generating laser 10. When the pulse is incident upon saturable element 50 that may be, for example, a semiconductor saturable element, the excitation of free carriers creates a refractive-index change. The refractive index begins to relax back to its original value immediately after the first pulse leaves. Therefore, a second pulse arriving at the saturable element 50 sees a time-varying refractive index that modulates the phase of the pulse and changes the carrier frequency. In this way, saturable element 50 has a memory that allows for a pulse-to-pulse coupling. In other words, saturating element 50 imposes a (negative) frequency chirp on the pulse, which decreases its group velocity and provides a feedback mechanism for maintaining equal time intervals between pulses. The frequency chirp means that a delayed pulse is slowed down less than a premature pulse, which shows that the phase modulation provided by the saturating element 50 is capable of retiming the pulses and stabilizing the repetition rate. To enable high repetition rates, it may be desirable for saturable element 50 to have a relaxation time (τ) comparable to the desired interval between the pulses in the cavity (T), i.e., significant phase modulation will occur for T/τ approximately equal to one.

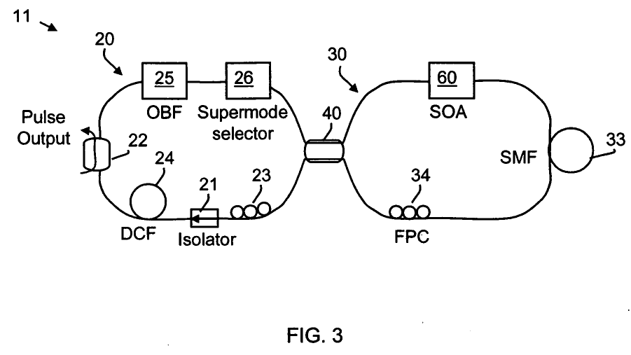

Turning to FIG. 3, a passive harmonic mode-locking fiber laser 11 with semiconductor optical amplifier (hereinafter “SOA”) based figure-eight laser is shown. In this scheme, an SOA 60 plays the role of both gain medium 31 and saturable element 50 from optical pulse generating laser 10. Typically, SOA 60 is realized with a thin layer of a semiconductor medium embedded between other semiconductor layers of wider bandgap. As one example, SOA 60 may be a GaAs quantum well embedded in AlGaAs, or InGaAs in GaAs. When the thickness of the thin layer of semiconductor medium is about five to twenty nanometers, the device is considered as quantum-well SOA. Alternatively, where the thickness of the layer is only a few nanometers, it is considered as quantum-dot or quantum-dash (i.e., a slightly elongated quantum-dot) SOA. As an example, a quantum-well SOA that has a carrier lifetime between one hundred picoseconds and one nanosecond will enable stable passive harmonic mode locking with repetition rates between one and ten gigahertz. To achieve higher repetition rates, a quantum-dash or a quantum-dot SOA with a carrier life time of approximately ten picoseconds might enable repetition rates of approximately one hundred gigahertz.

In one particular case, SOA 60, coupler 22, isolator 21, fiber polarization controllers 23, 34, a dispersion compensated fiber (hereinafter “DCF”) 24, a phase shifter 33, and a wavelength tuning element 25 are fiber coupled. Phase shifter 33 provides a nonlinear phase shift, and is typically formed of a short piece of fiber. The fiber may be, but is not limited to, standard telecom single-mode fiber that can be incorporated in optical loop 30. To minimize dispersion in the cavity and to allow the formation of mode-locked solitons, DCF 24 can be added either to optical loop 20 or optical loop 30. For example, if the components in optical loops 20 and 30 are made of a standard single-mode fiber with anomalous dispersion D1 and length L1, the DCF should have a normal dispersion D2 and length L2 that satisfy the equation: L1·D1+L2·D2≈0. In addition, wavelength tuning element 25 is added to select the peak operating wavelength of passive harmonic mode-locking fiber laser 11. Wavelength tuning element 25 may be, but is not necessarily limited to, an optical bandpass filter (hereinafter “OBF”) operable to change the wavelength of light propagated by the passive harmonic mode-locking fiber laser 11, and within a spectral gain profile of SOA 60.

In general, the fundamental frequency of the laser cavity, f_{c}, lies in the megahertz range. In order to obtain the gigahertz repetition rates, f_{R}, it may be desirable to harmonically mode-lock the laser at a very high-harmonic N of the fundamental frequency of the cavity, i.e., f_{R}=N·f_{c}. As a consequence of harmonic mode-locking, however, the laser cavity has a large number of competing modes or, in other words, N sets of cavity modes are synchronized and building so called supermodes. The generated N independent supermodes contribute to the laser emission and the beating between them leads to amplitude fluctuations of the mode-locked pulses. In addition, the pulse-to-pulse phase relationship is not fixed due to the fact that each supermode possesses its own carrier-envelope offset frequency, which is different from that of adjacent supermodes. Therefore to suppress the supermode beat noise and to obtain a fixed pulse-to-pulse phase relationship, a so called supermode selector 26 is added to mode-locked fiber laser 11 that provides loss to every supermode except one. Supermode selector 26 may be, but is not limited to, a Fabry-Perot etalon, a Mach-Zhnder interferometer, or a ring resonator, operable to select and stabilize one set of cavity modes among N possible supermodes. Note that supermode selector 26 may include a locking circuit to lock the modes of fiber laser 11 to those of mode selector 26.

In general, passive harmonic mode-locking fiber laser 11 may be configured with polarization-maintaining fibers to provide simplification and long-term operation without need for polarization maintenance. If, however, the components in passive harmonic mode-locking fiber laser 11 do not preserve the polarization, fiber polarization controllers 23 and 34 may be included in loops 20 and 30, respectively, as shown in FIG. 3.

In accordance with a further aspect of the invention, hybrid (active and passive) harmonic mode-locking can be realized to provide three different functions simultaneously: (a) control of the repetition rate, (b) suppression of the cavity's fundamental (non-oscillating) modes, and (c) reduction of both timing-jitter and amplitude-noise. Hybrid mode locking can be achieved through direct modulation of saturable element 50 that plays, in this case, the role of both passive and active phase modulator simultaneously. The modulating signal can be supplied to the saturable element using several different techniques. Two exemplary techniques include: (1) a regenerative feedback technique where the modulating signal is derived directly from the ring cavity using an optoelectronic feedback loop coupled externally to the laser cavity, and (2) an external RF generator operating in conjunction with a phase-locked loop (PLL) feedback control circuit.

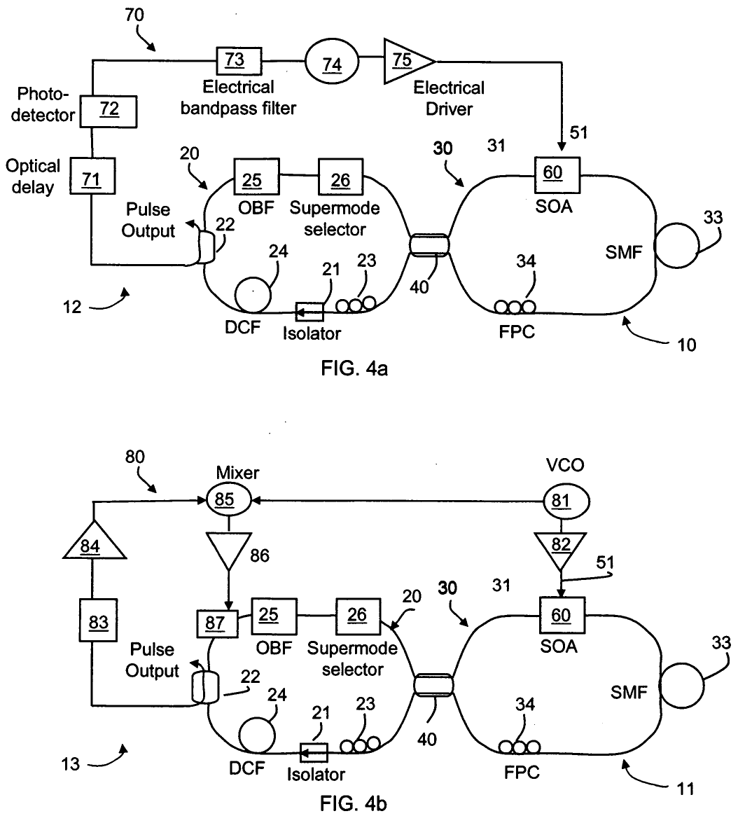

FIG. 4a describes an embodiment of the present invention. In particular, FIG. 4a shows a hybrid harmonic mode-locking fiber laser 12 using a fast saturable absorber-based figure-eight laser with an optoelectronic feedback loop. In hybrid harmonic mode-locking fiber laser 12, passive mode-locking is achieved using mode-locked pulse generating laser 11 as described in relation to FIG. 3 above, and active mode-locking is achieved through direct modulation of SOA 60 using an optoelectronic feedback loop 70. Optoelectronic feedback loop 70 is established between coupler 22 and an electrical driving port 51 of SOA 60 which acts as both gain medium 31 and saturable element 50. In some cases, saturable element 50 includes a bias input (e.g., port 51) for receiving a DC bias for passive mode locking and an electrical AC input for active mode locking.

Optoelectronic feedback loop 70 includes an optical path and an electrical path. A photodetector 72 is used to connect the two paths by converting the optical pulses into an electrical signal. The bandwidth of the photodetector 72 may be selected such that it is at least that of the desired repetition rate of the pulses. The optical path includes an optical delay line 71 that allows the realization of an extremely high-Q electro-optical microwave cavity. The electrical path of optoelectronic feedback loop 70 includes an electrical bandpass filter 73, an electrical phase shifter 74, and an electrical driver 75. In some cases, it is desirable that the electrical bandpass filter 73 has a passband that is narrower than the fundamental frequency mode spacing of pulse generating laser 10. The center frequency of electrical bandpass filter 73 determines the repetition rate of the optical pulses. Fine tuning of the frequency of oscillation can be achieved by adjusting electrical phase shifter 74.

In general, the phase stability (or phase noise properties) and spectral purity of the generated electrical sinusoidal signal in the optoelectronic feedback loop 70 are determined by the energy stored in the cavity of optoelectronic feedback loop 70 and the Q-factor of photonic-based delay line 71. Therefore, one key to obtaining an ultra-low timing-jitter performance for the optical pulses is to use a high-Q optical resonator together with shot-noise limited detection in the optoelectronic feedback loop to obtain an ultra-low phase-noise microwave source that drives SOA 60. In principle, photonic resonator 71 can be implemented using, for example, a long optical delay line, a whispering gallery-mode resonator, and/or a high Finesse Fabry-Perot resonator. Based on the disclosure provided herein, one of ordinary skill in the art will appreciate a variety of devices, and device characteristics that may be used in developing an optoelectronic feedback loop for controlling pulse generating laser 10.

FIG. 4b describes an embodiment of a hybrid harmonically mode-locked pulse generating laser 13 in accordance with other embodiments of the present invention. In hybrid harmonically mode-locked pulse generating laser 13 active mode-locking is achieved using a phase locked loop (hereinafter “PLL”) 80. The PLL includes VCO 81 used to modulate SOA 60 through a driver 82 and an electrical input 51. To synchronize VCO 81 and the laser cavity, a portion of the output optical pulses is detected and amplified using a photodetector 83 and amplified using amplifier 84. An electrical mixer 85 compares the phase of the laser's pulse rate to that of VCO 81 and generates an error signal fed back to the laser via a driver 86 and a transducer 87.

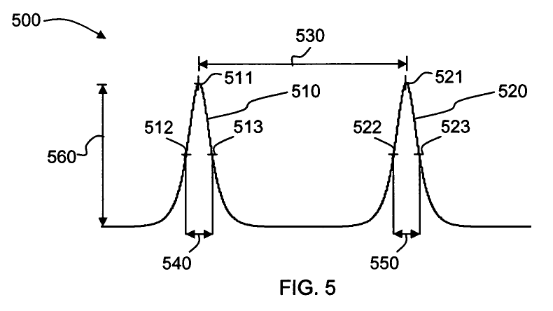

Turning to FIG. 5, an exemplary series 500 of two pulses 510, 520 that may be generated using one or more embodiments of the present invention are depicted. Pulses 510, 520 are of approximately equal amplitude 560, and have a period (T_{R}=1/f_{R},f_{R} being the repetition rate) 530 that is measured as the time from a peak amplitude 511 of pulse 510 to a peak amplitude 521 of pulse 520. It should be noted that this is one example of a period or repetition rate, and that one of ordinary skill in the art will recognize other definitions of period and/or repetition rates that would be equally viable and accord with one or more embodiments of the present invention. A length of pulse 510 may be broadly defined to be a width of pulse 510. Thus, for example, a length of pulse 510 may be the full width at half maximum of the pulse, i.e., a length 540 of pulse 510 is measured as the time that pulse 510 exceeds one half of amplitude 560 as marked by point 512 until pulse 510 returns to less than one half of amplitude 560 as marked by point 513. A length of pulse 520 is similarly measured as the time between a point 522 and a point 523. Based on the disclosure provided herein, one of ordinary skill in the art will recognize a variety of ways that the term “length” may be used in relation to embodiments of the present invention.

The invention has now been described in detail for purposes of clarity and understanding. However, it will be appreciated that certain changes and modifications may be practiced within the scope of the appended claims. Thus, although the invention is described with reference to specific embodiments and figures thereof, the embodiments and figures are merely illustrative, and not limiting of the invention. Rather, the scope of the invention is to be determined solely by the appended claims.

What is claimed is:

1. An optical pulse generating laser system for producing mode-locked optical pulses, the laser system comprising:
an optical pulse generation device, wherein the optical pulse generation device includes:
a first optical loop;
a second optical loop;
a beam splitter, wherein the beam splitter optically couples the first optical loop with the second optical loop;
an optical gain medium associated with the first optical loop; and
a saturable element disposed in at least one of the first optical loop and the second optical loop, wherein the saturable element is operable to modulate a group of optical pulses propagating in at least one of the first optical loop and the second optical loop to create a group of substantially regular modulated pulses.

2. The system of claim 1, wherein the optical gain element and the saturable element are implemented as a semiconductor optical amplifier.

3. A system for providing high repetition rate, ultra-short optical pulses, the system comprising:
an optical pulse generation device, wherein the optical pulse generation device includes a figure-eight optical path, wherein the optical pulse generation device includes a saturable element, and wherein the optical pulse generation device includes a cavity that can support multiple pulses.

4. The system of claim 3, wherein the figure-eight optical path includes:
a first optical loop;
a second optical loop;
a beam splitter, wherein the beam splitter optically couples the first optical loop with the second optical loop;
wherein the first optical loop includes an optical gain medium; and
wherein the saturable element is disposed in an optical loop selected from a group consisting of the first optical loop and the second optical loop.

5. The system of claim 4, wherein the saturable element is disposed in the second optical loop.

6. The system of claim 3, wherein the saturable element is formed of a material that exhibits an intensity-dependent transmission to enable propagation of multiple pulses within the cavity.

7. The system of claim 3, wherein the saturable element is selected from a group consisting of: a saturable gain medium and a saturable loss medium.

8. The system of claim 3, wherein the optical gain element and the saturable element are implemented as a semiconductor optical amplifier.

9. The system of claim 8, wherein the semiconductor optical amplifier is selected from a group consisting of: a quantum well semiconductor element, a quantum dash semiconductor element, and a quantum dot semiconductor element.

10. The system of claim 8, wherein the semiconductor optical amplifier modulates a group of pulses propagated by the optical pulse generation device to create a group of modulated output pulses, and wherein the length of the pulses in the group of modulated output pulses is less than one picosecond.

11. The system of claim 10, wherein the length of the pulses in the group of modulated output pulses is less than two hundred femtoseconds.

12. The system of claim 3, the system further comprising:
a dispersion control section, wherein the dispersion control section is operable to minimize the total dispersion in the laser cavity.

13. The system of claim 3, the system further comprising:
a wavelength tuning element, wherein the wavelength tuning element is operable to change the wavelength of light propagated by the optical pulse generation device within a spectral gain profile of the semiconductor optical amplifier.

14. The system of claim 3, the system further comprising:
a supermode selector, wherein the mode selector is operable to select and stabilize one set of cavity supermodes.

15. The system of claim 12, wherein the dispersion control section is formed by an optical fiber with appropriate dispersion and length.

16. The system of claim 14, wherein the supermode selector is formed by a group consisting of: Fabry-Perot etalon, Mach-Zehnder interfermometer, and a ring resonator.

17. The system of claim 3, wherein the optical pulse generation device includes an optical fiber, and wherein the optical fiber is a polarization maintaining fiber.

18. The system of claim 3, wherein the optical pulse generation device further includes a polarization controller.

19. The system of claim 1, wherein the system further comprises an optoelectronic feedback loop to control the repetition rate.

20. The system of claim 19, wherein the optoelectronic feedback loop includes:
an optical coupler, wherein the optical coupler is optically coupled to the optical pulse generation device; and
a photodetector, wherein the photodetector is optically coupled to the optical coupler, and wherein the photodetector converts the group of substantially regular modulated pulses received from the saturable element to a group of electrical pulses.

21. The system of claim 19, wherein the optoelectronic feedback loop further includes:
an electrical amplifier, wherein the electrical amplifier is electrically coupled to the photodetector, and wherein the electrical amplifier amplifies the group of electrical signals to form a corresponding group of amplified electrical signals; and
an electrical filter, wherein the electrical filter is operable to select a single frequency electrical signal from the group of amplified electrical signals and therefore to set a repetition rate based at least in part by providing an electrical signal for driving the saturable element.

22. The system of claim 19, wherein the saturable element includes a bias input for receiving a DC input for passive mode locking and an electrical AC input for active mode locking.

23. The system of claim 19, wherein the repetition rate is adjustable.

24. The system of claim 19, wherein the saturable element is a fast saturable element, and wherein the fast saturable element is operable to modulate a group of pulses propagated by the optical pulse generation device with a repetition rate greater than ten MHz.

25. The system of claim 24, wherein the repetition rate is greater than one GHz.

26. The system of claim 24, wherein the repetition rate is greater than ten GHz.

27. The system of claim 19, wherein the optoelectronic feedback loop further includes a long optical delay selected from a group consisting of: an optical delay line, a high-Q whispering gallery mode resonator, and a high-Q resonator.

28. The system of claim 19, wherein the optoelectronic feedback loop includes:
a VCO, wherein an RF output from the VCO modulates the saturable element and controls the repetition rate;
an optical coupler, wherein the optical coupler is optically coupled to the optical pulse generation device;
a photodetector, wherein the photodetector is optically coupled to the optical coupler, and wherein the photodetector converts the group of substantially regular modulated pulses received from the saturable element to a group of electrical pulses;
an electrical amplifier, wherein the electrical amplifier is electrically coupled to the photodetector, and wherein the electrical amplifier amplifies the group of electrical signals to form a corresponding group of amplified electrical signals;
an electrical mixer, wherein the electrical mixer compares the amplified electrical signal to that of the VCO and generates an error signal; and
a transducer, wherein the transducer controls the repetition rate.

29. The system of claim 28, wherein the transducer is a piezo electric transducer.
